(19) United States
(12) Patent Application Publication
(10) Pub. No.: US 2018/0158118 A1
(43) Pub. Date: Jun. 7, 2018

(54) Household (Personal Goods) Management System

(71) Applicant: Michael Paul Tolbert, Greenville, SC (US)

(72) Inventor: Michael Paul Tolbert, Greenville, SC (US)

(21) Appl. No.: 15/393,539

(22) Filed: Dec. 29, 2016

Related U.S. Application Data
(60) Provisional application No. 62/272,216, filed on Dec. 29, 2015.

(51) Int. Cl. G06Q 30/06; G06K 7/10; G06F 17/30

(52) U.S. Cl. CPC G06Q 30/06; G06F 17/30943; G06F 17/30861; G06K 7/10

(57) ABSTRACT

Household (personal) Goods Management System is intended to bring visibility, accountability and valuation to physical goods people own within their homes/living spaces, storage units, hotels, etc. This solution allows for a wide range of user managed transactions of their personal goods through an application (“app”) software/hardware to include but not limited to: better organizing and accounting for, selling, sharing, trading, donating personal belongings, personal estate management, personal asset allocations, etc.

Any US Government Agency that has a property interest in the Invention: N/A, none

### DRAWINGS

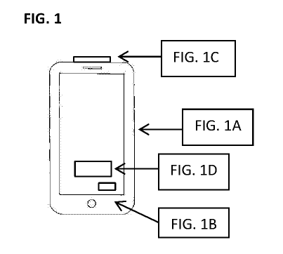

1. FIG. 1—Smart Phone/Tablet

a. FIG. 1A: Application/software for use with and fully compatible with Smartphones, Non- smart phones, Tablets, etc.

b. FIG. 1B: Application icon to enter the software platform/operating system

c. FIG. 1C: Radio Frequency (barcode reader) functionality, through use of camera or added phone barcode reader option

d. FIG. 1D: Advertisements for various purposes (i.e. messages, businesses, special interests, specific causes, etc.)

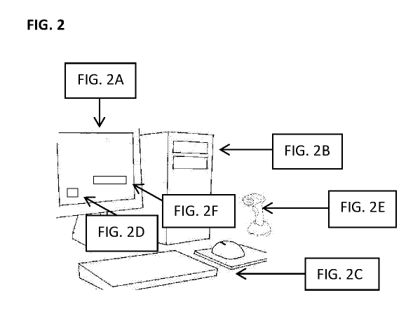

2. FIG. 2—Personal Computer

a. FIG. 2A: Application/software for use with and fully compatible with Personal Computers, Laptops, any Home based or portable computer unit, etc.

b. FIG. 2B: Computer tower

c. FIG. 2C: Computer keyboard and mouse

d. FIG. 2D: Application icon to enter the software platform/operating system

e. FIG. 2E: Radio Frequency (barcode reader) functionality, through use of camera or barcode reader device/accessory for the PC

f. FIG. 2F: Advertisements for various purposes

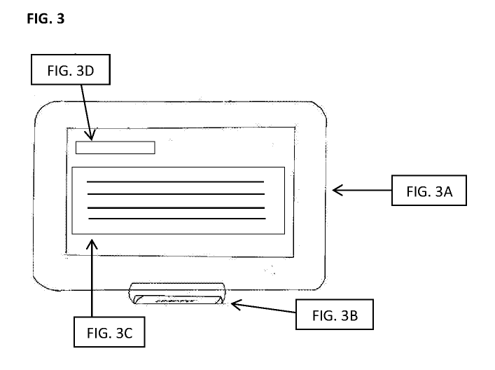

3. FIG. 3—Home-installed Digital Database System

a. FIG. 3A: Application/software for use with and fully compatible with Home-installed Digital Database System

b. FIG. 3B: Radio Frequency (barcode reader) functionality, through use of built in barcode reader

c. FIG. 3C: Application software platform interfaced with the primary operating system

d. FIG. 3D: Advertisements for various purposes

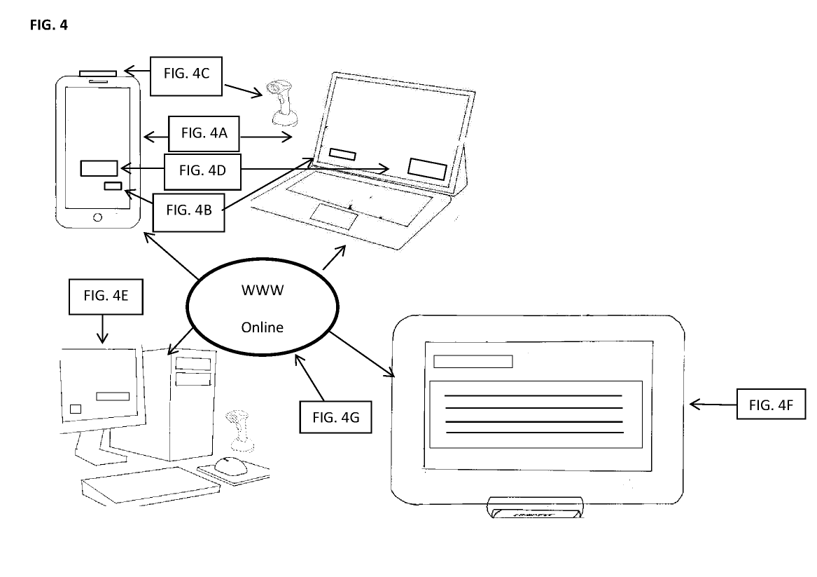

4. FIG. 4—Connectivity between Smartphones/Tablets, Personal Computers and Home System

a. FIG. 4A: Application/software for use with and fully compatible with Smartphones, Non-smart phones, Tablets, etc.

b. FIG. 4B: Application icon to enter the software platform/operating system

c. FIG. 4C: Radio Frequency (barcode reader) functionality, through use of camera or added phone barcode reader option

d. FIG. 4D: Advertisements for various purposes

e. FIG. 4E: Application/software for use with and fully compatible with Personal Computers, Laptops, any Home based or portable computer unit, etc.

f. FIG. 4F: Application/software for use with and fully compatible with Home-installed Digital Database System (TBC)

g. FIG. 4G: System is fully capable of being online, connected to worldwide web (Internet/Wi-Fi/Ethernet, etc.) for global access and real time visibility to all users

h. FIG. 4H: All devices not limited to those mentioned above are compatible in communicating with each other through this application/software.

1. A software program/application for use on or with any computer device (i.e. any digital device including phone, tablet, laptop, desktop, computer, etc.) to manage, have visibility and organize all personal belongings, household goods to include but not limited to personal/family wardrobes, shoes, accessories, under garments, jewelry, hats, glasses, kitchen utensils, tools, etc. Said claim:
Will/is comprised of use of technology to form a house/home/temp living space (i.e. lodging/hotel, etc.) inventory management system through use of secured, safe platform which is a compatible digital device including tablet, laptop, desktop computer, phone functionality and software.
Personal goods inventory management system stated in claim A is provided in multiple forms—basic through advanced systems, with the flexibility to minimize or bring fully automated infrastructure into the household to physically store and retrieve household goods in/out of designated storage locations (i.e. closets). Said household inventory management system will provide options for households to determine what best suits their needs and budget.
With advanced household inventory management system stated in claim B, infrastructure will be installed in homes to support organized storage of household goods through storage units, closets, etc. aimed at taking advantage of current unutilized space. Said infrastructure will be customized for each location of installation to best fit the needs of each specific location as necessary, otherwise will use standard infrastructure as it fits the location specifically.
With technology stated in claim A, gives the ability and option to bring and connect online through the internet to (1) provide purchase, current market, and/or future market value of all/some/most items in your personal inventory management system (as possible). (2) With online access and value assignments of personal inventory assets able to provide net value as a whole or filtered by certain product/item types or groups, or customized by preference by purchaser, manager, household owner/users, etc.
With internet access stated in claim D provides the ability to share visibility of personal inventory items with social networks, public, friends, anyone with the ability to access the internet, but with security controls to limit or manage visibility to as many or as few, or no one else based on personalized settings. Said visibility and access control management allows for the ability to lend out, borrow, sell, auction, purchase, valuate, show off or maintain personal items as desired.
With access control and internet usage stated in claim E, provides the ability to connect/link to online communities/markets such as but not limited to EBay, Amazon, Facebook, or any other online communicate/market in which selling items, renting items, auctioning items, showing off items in any form, valuating items and giving general visibility of items are possible, in order to execute any one or a combination of either of these actions. Said functionality will include item description as reflected in the household inventory management system, value based on purchase/current market/future estimated value, etc. and an image of the items as marketed as best as possible (when feasible).
With technology solution stated in claim A-F, provides the ability to generate recommendations to include wardrobe recommendations, aged items, potential items for disposition, attractive/real time hot items for sale, etc.
With technology and infrastructure stated in claim A-G, provides the ability to customize a solution for any livable space to include but not limited to: homes—houses/households, apartments, condos, townhouses, duplexes, hotel rooms, offices, studios, etc.
With the technology and infrastructure stated in claim A-H, will be powered through a variety of optional sources to include by not limited to battery powered, electricity through electrical outlets/power sources, battery backup option and/or solar power option as an energy efficient method to power automated infrastructure solutions.
With the technology and infrastructure stated in claim A-I, the controlling/visibility management devices are capable of operating on all computer system platforms to include, but not limited to: Android, IPhone, Microsoft and all other compatible operating hardware/software platforms.
